(19) United States
(12) Patent Application Publication
(10) Pub. No.: US 2010/0083177 A1
(43) Pub. Date: Apr. 1, 2010

(54) Using tags with operator interface panels

(76) Inventors: Rajesh K. Tiwari, Naperville, IL (US); Raymond Husman, Urbana, IA (US); Rajashekhar Kada, Chennai (IN); Sankaranarayana R. Krishnamoorthy, Chennai (IN); Mark Hockert, Bettendorf, IA (US)

Correspondence Address: PYLE & PIONTEK, LLC, 221 N LASALLE STREET , ROOM 1207, CHICAGO, IL, 60601, US

(21) Appl. No.: 10/354,860

(22) Filed: Jan. 30, 2003

(51) Int. Cl. G06F 3/048

(52) U.S. Cl. 715/821; 715/806; 711/E12.002

(57) ABSTRACT

The invention describes use of tags in an operator interface panels. The tags are descriptive names of variables used in the panel. The use of tags allows a user to use meaningful names to the variables used with the objects on the panel.

### FEDERALLY SPONSORED RESEARCH

Not applicable.

### SEQUENCE LISTING OR PROGRAM

Not applicable.

### BACKGROUND

1. Field of Invention

This invention relates to Operator Interface Panels, specifically to use of tags with the panels.

2. Discussion of Prior Art

The Operator Interface Panels are also known as Touch Panels, Touch Screens, Man Machine Interfaces (MMI) and Human Machine Interface (HMI). In this document, Operator Interface Panel and HMI are used synonymously. This discussion does not include software-based HMIs that run on a PC or a general-purpose computer system. Rather we cover here the operator interface panels with a dedicated microprocessor.

In many cases Electronic Operator Interface Panels replace much of the hardwired control components from an automation panel, such as Push Button, Indicator Lights, Pilot Lights, Meters, etc. The recent trend in industrial automation shows an increased use of HMI's. The reasons for this trend are:
1. Operator Interface Panels or HMIs save premium panel space.
2. HMIs are cost effective alternative to hardwired control components.
3. Automation panels using HMI can easily be reconfigured as compared to the ones using hardwired controls.
4. Control components can easily be added or deleted from HMI screens as compared to adding/deleting hardwired components from the panel.
5. HMIs offer much more than push buttons and pilot lights. For example, the modern HMIs will allow you to use Bar graphs, Trend Graphs, Alarm capabilities, etc., on screens.

HMIs are used to mimic a variety of hard-wired control components, such as Push Buttons, Pilot Lights; etc. A hardwired Push Button when pressed turns on/off power to some device. HMI mimics a Push Button by displaying a graphic representation of Push Button, and when this graphic is touched, the HMI would set or reset a bit in controller. This bit inturn may turn power on or off to the device.

During screen design, a programmer would place the Push Button graphics on the screen of HMI, and associate it with a bit in controller to enable HMI writes to this bit. Similarly, HMI mimics a Digital Display by reading values from a register in controller memory and displaying them. In this case the programmer would associate a register address with the digital display during screen design.

HMIs support a variety of control objects. Depending upon the type of object, the programmer may have to associate the object with one or several addresses of controller memory. These addresses may be of bit type (discrete), single word, or multi-word type. For example, a push button requires a single bit address, an indicator button needs two single-bit addresses, while a recipe button require multiple, possibly multi-word addresses.

In most HMIs, a programmer needs to use the syntax of the controller's address (or very close to it) for defining address. Below are few examples of bit addresses of some popular controllers:
N7:100/15
40000/1
V1000

As is obvious, the syntax for the address varies between different controllers. The syntax involves either numbers, or a mix of letters & numbers. These addresses are not inherently descriptive, i.e. by looking at the address one cannot say how or where the address has been used. The syntax is hard to remember and can easily get mixed up. Mistakes due to mix up are very hard to track & debug.

Many HMIs work with controllers made by several different manufacturers. In this case, the HMI screen designer has to know the address-syntax for each of the controller that the designer has to design screens for.

Screen designers face another problem when screens designed for one PLC type have to be ported for use with another PLC type. In this case, in most HMIs, one has to either start all over again and design the screens from scratch, or edit each object to change the address-syntax associated with the object to that of the new PLC type.

3. Objects and Advantages

This invention describes a tag based addressing scheme for HMIs that are capable of working with controllers from different manufactures. The scheme uses a Tag, or a name for the address, with the screen objects, instead of only using address in native syntax of controller.

### SUMMARY

The invention describes a tag based addressing scheme for use with HMIs that work with a variety of controllers. Tag based addressing allows HMI screen designers to use meaningful Tags (or names) for controller addresses. Subsequently the tag can be associated with the native address of controller. This offers many advantages:
1. Meaningful, descriptive names are easier to remember
2. Descriptive names are self documenting
3. HMI Screen designers can design screens without knowing anything about the syntax of controller address.
4. HMI screens & Controller logic can be developed independent of each other, and address association can be done at the final stage of the project.
5. The Tag based addressing described here allows user to change PLC type for a project without having to start all over, or to edit every object.

### DRAWINGS

FIG. 1 shows a system block diagram of a industrial control system which uses HMI.

FIG. 2 shows a PC showing two objects on the screen.

FIG. 3 shows an HMI with two objects and connected to the controller

FIG. 4 shows a partial dialog box for tag name entry

FIG. 5 shows a dialog box for tag detail entry

FIG. 6 shows a partial flowchart relevant for tag name processing when entered by user

FIG. 7 shows an object and tag database.

FIG. 8 shows a block diagram of relevant software components and their interactions.

### DESCRIPTION OF PREFERRED EMBODIMENT

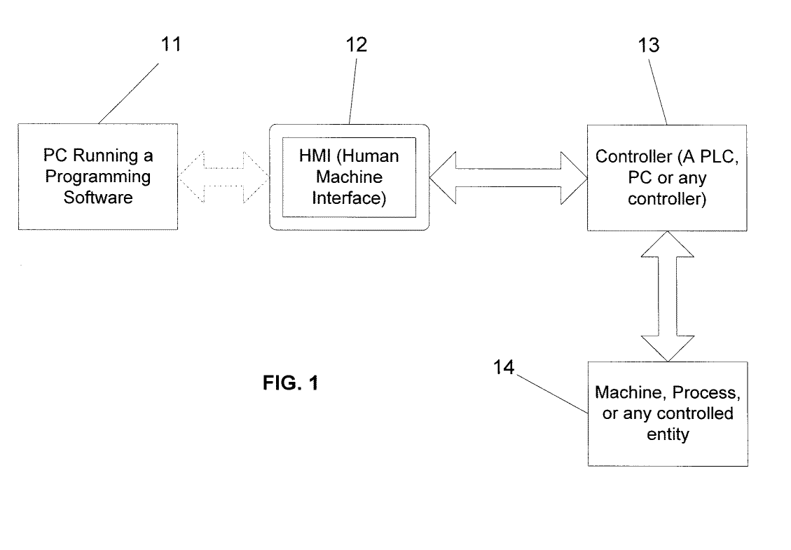

FIG. 1 shows a block diagram of a typical control system showing application of HMI. PC 11 is used to design screens for the HMI 12, which allows operators to interact with controller 13 controlling a machine, process or any other entity 14.

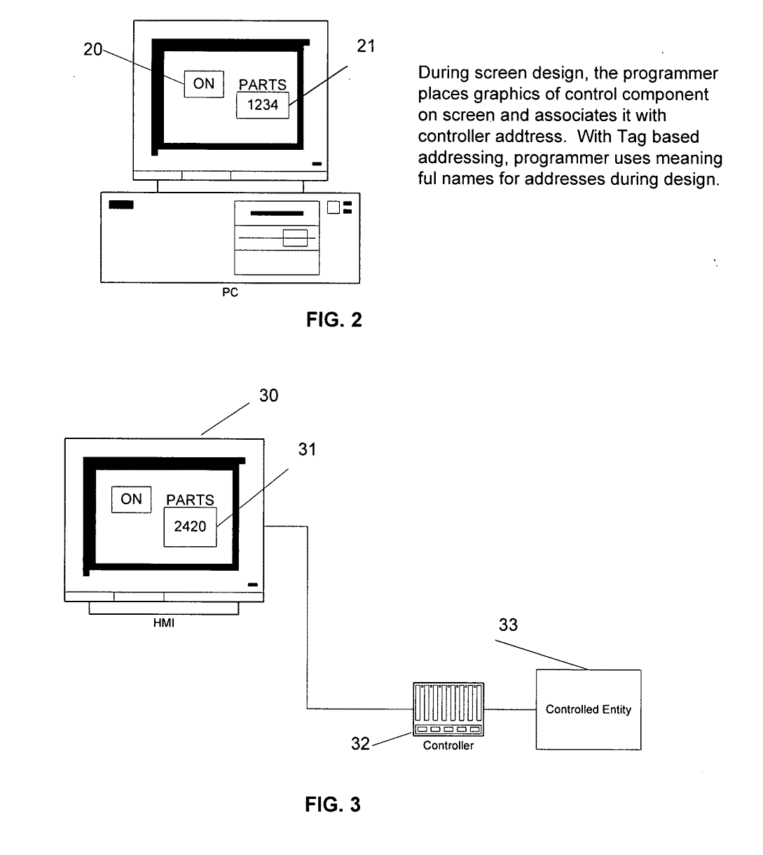

FIG. 2 shows a PC with a screen being designed on it. The screen has two objects for illustration, a push button 20, and a digital display 21.

FIG. 3 an HMI 30 connected to a controller 32, which is controlling entity 33. There are two objects on the HMI screen for illustration, a Push button, and a digital display 31.

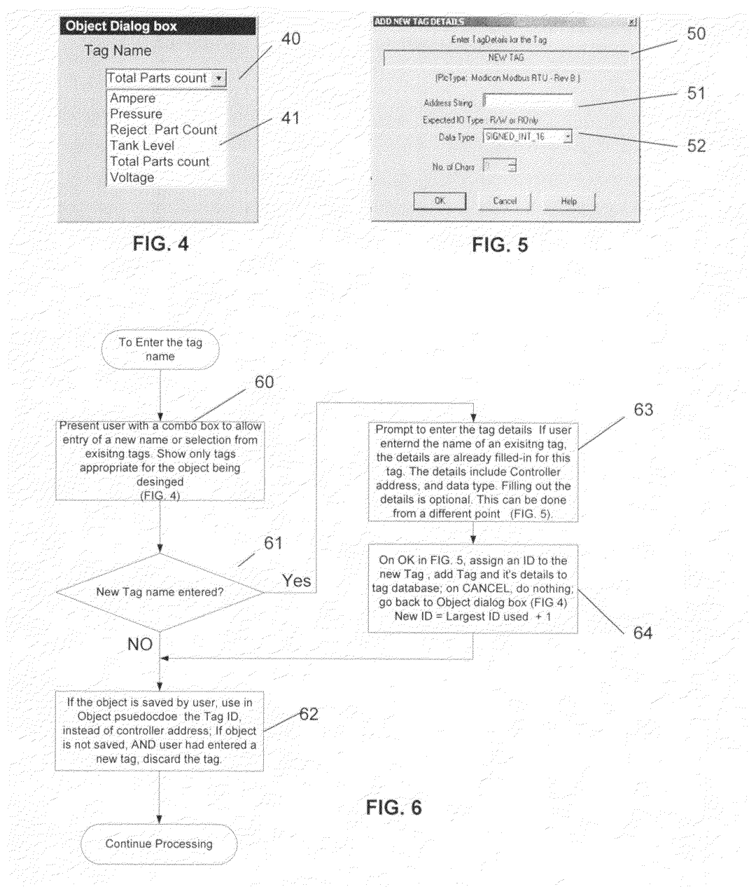

FIG. 4 shows a portion of object design dialog box, which is relevant to tags. It shows a combo box to allow user to enter/select a tag name.

FIG. 5 shows a dialog box for entry of tag details. It shows the tag name entered by the user 50, an edit box for controller address entry 51, and a drop down list box for data type 52.

FIG. 6 shows a flow chart relevant for tag entry.

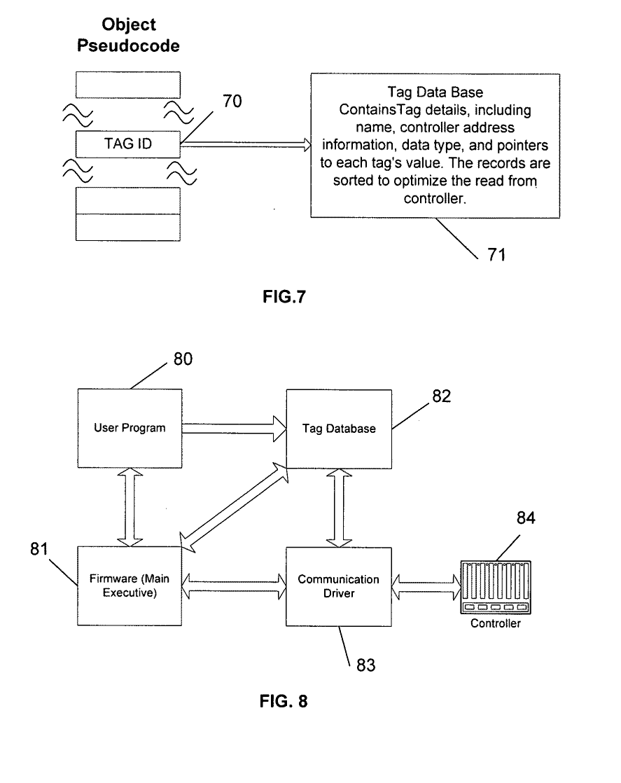

FIG. 7 shows object pseudo-code and it's relation to tag database.

FIG. 8 shows a block diagram for the software components relevant to tags and their interactions.

### Operation

FIG. 1 shows a block diagram of a typical control system showing application of HMI. PC 11 is used to design screens for the HMI 12, which allows operators to interact with controller 13 controlling a machine, process or any other entity 14.

A programmer designing screens for HMIs uses a screen-design software specific to the HMI. To design the screens the programmer places graphical representation of control components on the screens. Some of these components will read and/or write data from associated controller memory. The Programmer will make this association during the screen design. With tags, programmer will enter a tag name or select one of the existing tags. As an example, in FIG. 2, a programmer has placed two objects, a push button 20 and a digital display 21 on the screen. The push button will be associated with a bit in the controller (or within the HMI), while the digital display will be associated with a data register of required length and format.

Once the designed screens are transferred to the HMI, HMI will read and write to the controller's memory as & when needed. For example, the digital display-graphic displays value of register(s), so the HMI continuously reads the value of associated register(s) from the controller memory. In the example of FIG. 3, the HMI 30 screen shows the digital display graphic 31 reads the value 2420. The value has come back from controller 32.

FIG. 6 shows a partial flow chart for the processing of the tag when a new object is defined. When the user selects a new object, a dialog box to fill-in properties for that object comes up (60). If the object requires one or more data values, the dialog box will have the Tag entry fields for those values. The tag entry field is a combo box as shown in FIG. 4, allowing the user to enter a new name or select a name from the drop down list of already defined tags in the project. The list 41 in the combo box 40 displays only the tags appropriate for the object. For example, if the user is programming a push button, then the list will contain only the tags with discrete or bit type of data values.

If user selects a tag name from the already defined tags, nothing needs to be done as far as tag creation is concerned. When object is saved, the screen-design software saves the Tag ID of the selected tag in the psuedo-code of the object (FIG. 7).

If user types in a tag name, the name is checked for duplicity. A tag detail entry dialog box shown in FIG. 5 comes up. If it is a duplicate name, the detail box is already filled-in with the details of the tag already in the database. If it is a new name, the user can optionally enter the controller address.

If the user does not associate the tag with controller address 50, the tag is considered an internal tag, i.e. the tag is internal to the HMI. Its value is within the HMI. The user can always change that by associating a controller address with it later on. If the user enters the address, a syntax check is made on the address. If syntax is invalid for the controller selected for this project, the user is notified, and returned to the entry dialog box. In addition to the controller address, user needs to enter the data type 52. Once the user clicks OK on the tag detail entry dialog box, a Tag ID is assigned to the new tag name. The new Tag ID equals the largest ID used plus one. If the programmer saves this object in the project, the new tag is saved in tag database otherwise the tag is discarded. In any case when object is saved, the Tag IDs are saved along with the pseudo code of the object.

The user can also enter the tags directly, without going through the dialog box of an object. By using the Tag data base one can enter the tags directly, which can later be used for selecting the tags from Tag Name combo boxes.

When a Tag is defined by the user (either through an object or through the database) by defining it's name, optionally associated controller address, and data-type, the screen design software creates a record for it. The record contains all the relevant data about the tag. The data structure of the record as used in one implementation is shown below:

TagList
{

| | |
|---|---|
| int m_nCategory; | // Category defined in editor for determining the type |
| | // Of objects this tag can be used with |

long unsigned m_nLink; // Number of objects using this tag
unsigned int m_nIndex; // Tag ID
CString m_strTagName; // Tag name (null terminated string)
unsigned char m_nDataType; // data type from enumerated list
unsigned char m_nIOType; // defines Read-only or Read/write address
char* m_strMapString; // Controller address in internal format
long unsigned m_nValueOffset; // Not used
CString m_strAddress; // User entered address
unsigned int m_nNoOfChars; // number of char for ASCII data type
bool m_bIsInternal; // indicates if it's internal or controller tag

}

Basically the idea here is to capture the information and organize it. We show here one implementation, but it can be done in a number of different ways.

Once all screens are designed, the design is transferred to the HMI. Only the relevant data is transferred to the HMI. The data that can be reconstructed is typically not sent to the HMI to conserve the memory in HMI.

One implementation keeps Tag data in the HMI in the following structure:

typedef struct

| | | |
|---|---|---|
| { | | |
| IO_TYPE | access; | /* type of access allowed */ |
| char | active; | /* if non-zero driver updates value */ |

| | | |
|---|---|---|
| VALUE_TYPE | value_type; | /* type of value to read or write */ |
| unsigned char | value_size; | /* number of bytes required to hold value */ |
| void | *value; | /* points to tag value */ |
| unsigned char | *map; | /* points to tag map */ |
| char | *name; | /* points to tag name */ |
| } TAG; | | |

The structure is constructed by the firmware when the project is received by the HMI. The tag name, address, and values are stored in some other memory; the structure stores only the pointers to those areas.

During the operation of HMI (FIG. 8), the HMI displays screens on the display, and updates information on the display by reading/writing to the controller. Firmware 81 decides for which tags the values need to be updated, based on the screen on display and based on all the registers those must be read in the background. The tags are marked as active tags in the tag database 82, and then the executive requests driver 83 to update those tags. The driver in turn follows communication protocol of the controller to read/write appropriate tags.

As mentioned in the summary above, one of the advantages of the tag based addressing is that it introduces controller-independence in screen design. A programmer can switch the target controller relatively easily with this invention. All that has to be done is to select a desired controller. The screen-design software then compares the syntax of the current controller with the new target controller. If the two syntaxes are the same, all the address information is retained, except, if the target controller does not support some of the address ranges, the tags with addresses within unsupported ranges are converted to internal tags. If the two syntaxes are different then all the address information is deleted, and user is required to enter the address information for all tags. This can be done from a single place (tag database), and all screen designs remain unchanged. This is a real benefit to OEMs who have to use controllers based on customer's specifications, but may use any HMI.

Included CD has a screen design software, called PowerPanel Programming software. The software runs on a PC running Windows 98, NT, 2000 or XP operating system with at least 800×600 screen resolution. To install the software follow the instructions given below:
1. CD has an auto run feature, i.e. once you insert the CD, it would automatically run the setup program to install the screen design software. Follow on screen instructions to install the software.
2. If for any reason, the CD does not auto run, please explore the CD, Find Setup.exe file and run it. Follow on screen instruction to complete the installation.

To experience the ease of programming with the tags, design screens for any target controller (supported by the software) using the software. Use tag names and look at the tag database.

We claim:

1. An electronic operator interface panel having a dedicated microprocessor, with means to electrically connect to a machine controller, and with means to electrically connect to a programming device, having objects that provide operator input to the machine and/or machine status to the operator, having means to associate said objects with memory addresses in said controller and/or in said panel, and said addresses having descriptive alphanumeric names, for ease of programming said objects.

2. The panel of claim 1 with means of checking the syntax of said controller's memory address at the time of entry of the address.

3. The panel of claim 1 with means to switch the model and/or type of said machine controller without need to re-enter said names.

4. The panel of claim 1 with means of viewing a where-used list for a name from the list of said descriptive names.

5. The panel of claim 1 with means to highlight names, from all said names, defined in user program but not associated with any objects.

6. The panel of claim 1 with means of automatically deleting said highlighted names.

7. The panel of claim 1 with means of highlighting said names not associated with said controller's memory addresses.

8. The Operator interface panel of claim 1 wherein said visual means to provide operator input and machine status comprise of a graphical display.

9. The Operator interface panel of claim 8 wherein said graphical display contains objects that can provide operator input to the machine controller by touching said objects.

10. The Operator interface panel of claim 8 wherein said graphical display comprises of a liquid crystal display or a plasma display or a cathode ray tube, or any other new graphical display technology.

11. The Operator interface panel of claim 8 having electrical and mechanical means to connect a touch screen to the said graphical display.

12. A method to use descriptive names in an operator interface panel, comprising:
a. Providing a machine controller with memory,
b. Providing objects to provide operator input to the machine and/or machine status to the operator,
c. Providing means of associating descriptive name with said objects, and with said descriptive names.
Whereby allowing users to use meaningful descriptive names for addresses associated with objects.

13. A method of claim 12, comprising:
a. Checking the syntax of said controller's address associated with said descriptive names at the time of entry of the address.

14. A method of claim 12, comprising:
a. Providing means for viewing a list of all descriptive names not associated with any of said objects.

15. A method of claim 12, comprising:
a. Providing means to delete said descriptive names un-associated with said objects.

16. A method of claim 12, comprising:
a. Providing means to view a list of all said objects which are associated with a given descriptive name.

17. A method of claim 12, comprising:
a. Providing a means to view said descriptive names un-associated with said controller's memory address.
